(19) United States
(12) Patent Application Publication
(10) Pub. No.: US 2025/0287466 A1
(43) Pub. Date: Sep. 11, 2025

(54) ELECTRIC BLANKET

(71) Applicant: STAR ELITE INC., Montreal (CA)

(72) Inventors: WING-NIN NG, Fanling (CN); LUO TIANMING, Xinshao County (CN); XIA YIBING, Longshan County (CN); ZHANG LIHUA, Ningling County (CN)

(73) Assignee: STAR ELITE INC., Montreal (CA)

(21) Appl. No.: 18/600,078

(22) Filed: Mar. 8, 2024

(51) Int. Cl. H05B 1/02; H05B 3/34

(52) U.S. Cl. CPC H05B 1/0272; H05B 3/342

(57) ABSTRACT

An electric blanket includes a first heating element, a second heating element, and a controller operatively coupled to the first heating element and the second heating element, wherein the controller is configured to obtain a heat setting, alternately apply a voltage to the first heating element for a pre-heat duty cycle and to the second heating element for the pre-heat duty cycle for a total pre-heat time period based at least in part on the heat setting, and alternately apply the voltage, after the total pre-heat time period, to the first heating element for an operating duty cycle and the second heating element for the operating duty cycle based at least in part on the heat setting.

### FIELD

The present disclosure generally relates electric blankets, and more particularly, to battery operated electric blankets.

### BACKGROUND

Blankets may include an electronic device to help to heat the blanket. Electric blankets typically include an electric heating element that turns power into heat that transfers into the blanket. A typical electric blanket may use between 100 and 150 watts of power during operation. Electric blankets generally include a cord to be plugged into a wall outlet in order to draw the 100 to 150 watts of power during use.

Some electric blankets may obtain power from a battery. However, the battery may quickly lose power, particularly when powering a strong heating element. Therefore, a need exists for a system that uses less battery power and will allow the battery to last longer.

### SUMMARY

Disclosed herein is a system including a first heating element, a second heating element, and a controller in communication with the first heating element and the second heating element. The controller is configured to obtain a heat setting, alternately apply a voltage to the first heating element for a pre-heat duty cycle and to the second heating element for the pre-heat duty cycle for a total pre-heat time period based at least in part on the heat setting, and alternately apply the voltage, after the total pre-heat time period, to the first heating element for an operating duty cycle and the second heating element for the operating duty cycle based at least in part on the heat setting.

In various embodiments, the system further includes a fabric material enclosing the first heating element and the second heating element. In various embodiments, the heat setting indicates a pre-heat setting and an operating setting, wherein the pre-heat setting defines the pre-heat duty cycle and the total pre-heat time period, and wherein the operating setting defines the operating duty cycle. In various embodiments, the alternately applying the voltage includes applying the voltage only to the first heating element for a first time period and applying the voltage only to the second heating element for a second time period after the first time period, the second time period being equal in length to the first time period.

In various embodiments, the first time period is about 5 ms to about 15 ms. In various embodiments, the pre-heat duty cycle is 100% on and the operating duty cycle is about 15% to about 75% on and about 25% to about 85% off. In various embodiments, the total pre-heat time period is about 5 minutes to about 60 minutes.

Also disclosed herein is a system including a power source, a first heating element in communication with the power source, a second heating element in communication with the power source, a processor in communication with the power source, the first heating element, and the second heating element, and a memory in communication with the processor. The memory includes instructions stored thereon that, when executed by the processor, cause the processor to obtain a heat setting, alternately apply a voltage from the power source to the first heating element for a pre-heat duty cycle and a first time period and to the second heating element for the pre-heat duty cycle and the first time period for a total pre-heat time period based at least in part on the heat setting, and alternately apply the voltage from the power source to the first heating element for an operating duty cycle and a second time period and the second heating element for the operating duty cycle and the second time period based at least in part on the heat setting.

In various embodiments, the system further includes a fabric material configured to enclose the first heating element and the second heating element. In various embodiments, the heat setting indicates a pre-heat setting and an operating setting, wherein the pre-heat setting defines the pre-heat duty cycle and the total pre-heat time period, and wherein the operating setting defines the operating duty cycle. In various embodiments, the first time period is equal to the second time period. In various embodiments, the pre-heat duty cycle is 100% on and the operating duty cycle is about 15% to about 75% on and about 25% to about 85% off.

In various embodiments, the total pre-heat time period is about 5 minutes to about 60 minutes. In various embodiments, the first time period is about 5 ms to about 15 ms.

Also disclosed herein is a method including obtaining, by a processor, a heat setting, applying, by the processor, a voltage alternately to each heating element of a plurality of heating elements for a total pre-heat time period based at least in part on the heat setting, the voltage being applied to each heating element of the plurality of heating elements according to a first duty cycle, and applying, by the processor in response to the total pre-heat time period expiring, the voltage alternately to each heating element of the plurality of heating elements according to a second duty cycle based at least in part on the heat setting.

In various embodiments, the applying the voltage alternately further includes applying the voltage according to the first duty cycle to each heating element of the plurality of heating elements for a first time period and applying the voltage according to the second duty cycle to each heating element of the plurality of heating elements for a second time period. In various embodiments, the heat setting indicates a pre-heat setting and an operating setting, wherein the pre-heat setting defines the first duty cycle and the total pre-heat time period, and wherein the operating setting defines the second duty cycle.

In various embodiments, the method further includes receiving, by the processor, a input signal indicating the heat setting and storing, by the processor, the heat setting in memory. In various embodiments, the first duty cycle is about 90% to about 100% on and about 10% to about 0% off, and wherein the second duty cycle is about 15% to about 75% on and about 25% to about 85% off. In various embodiments, the total pre-heat time period is about 5 minutes to about 60 minutes.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an exemplary electric blanket including a power source and multiple heating elements, in accordance with various embodiments.

FIG. 2 illustrates an exemplary system diagram of an electric blanket including a power source and multiple heating elements, in accordance with various embodiments.

FIG. 3 illustrates a flow diagram of an exemplary method of heating an electric blanket including multiple heating elements, in accordance with various embodiments.

### DETAILED DESCRIPTION

An electric blanket may include a plurality of heating elements that are housed inside of a fabric material. The electric blanket may include a battery that supplies power to the plurality of heating elements and a controller configured to control the power to the plurality of heating elements. In various embodiments, the controller may be configured to alternately provide power to each heating element of the plurality of heating elements. The power provided to each heating element may include full or partial power. In various embodiments, alternately providing power to each heating element allows each heating element of the plurality of heating elements to draw less power, while providing (or feeling like it provides) a similar amount of heat as a larger heating element that draws more power. In various embodiments, alternately providing power to each heating element of the plurality of heating elements tends to increase the life span of the battery.

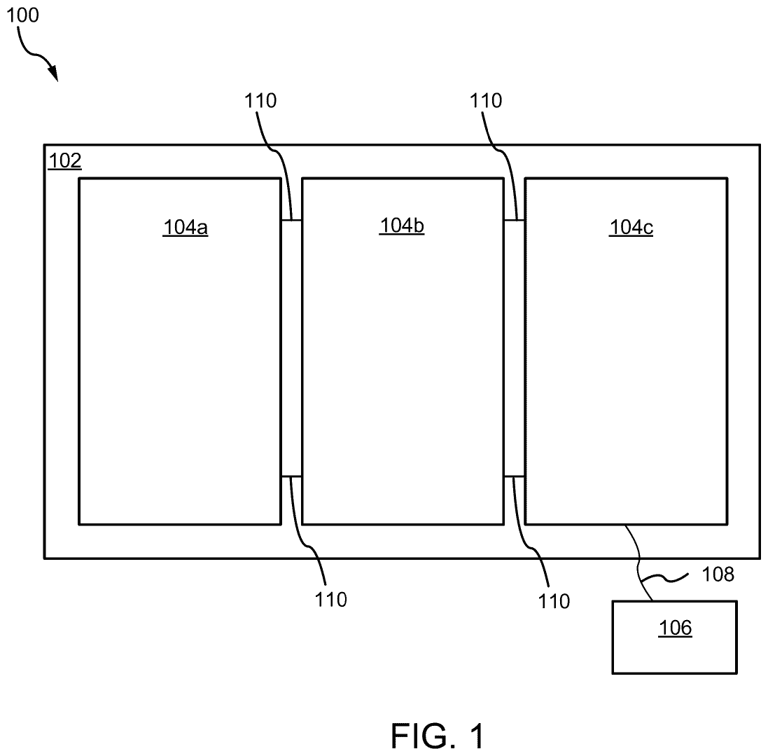

Referring now to FIG. 1, an electric blanket 100 is illustrated, in accordance with various embodiments. Electric blanket 100 includes a blanket 102, a plurality of heating elements 104, and a control module 106. The plurality of heating elements may include any number of heating elements, but three heating elements 104a, 104b, 104c are shown in FIG. 1 as an example. Control module 106 may include a battery and a controller for controlling electric blanket 100. In various embodiments, control module 106 may be coupled to electric blanket 100 and the plurality of heating elements 104 by a control line 108. In various embodiments, control line 108 may provide power to the plurality of heating elements 104. In various embodiments, controller may include one or more control lines 108, wherein each control line 108 provides power and control signals to one or more of the plurality of heating elements 104. In various embodiments, one control line 108 may provide power and control signals to one or more of the plurality of heating elements 104. In various embodiments, power and/or control signals may be provided to each heating element 104a, 104b, 104c directly from controller 106 and/or by control lines 110.

In various embodiments, blanket 102 may be manufactured from any suitable material including cotton, polyester, wool, flannel, fleece, nylon, taffeta, and/or silk, among others. In various embodiments, the material of blanket 102 may be an insulative material that is designed to retain heat generated by the plurality of heating elements 104a-104c. In various embodiments, blanket 102 may include a plurality of pouches (or other structures) to hold and secure one or more heating elements of the plurality of heating elements 104. In various embodiments, the plurality of pouches may hold each heating element separately from each other heating element of the plurality of heating elements 104.

In various embodiments, the plurality of heating elements 104 may include a flexible material that allows blanket 102 to move and bend. In various embodiments, each heating element 104a, 104b, 104c may include one or more of a ceramic, a carbon fiber, a nickel-chromium alloy, an iron-chromium-aluminum alloy, a molybdenum disilicate, Graphene, and/or a silicon carbide, among others. In various embodiments, each heating element 104a, 104b, 104c may physically be any size, different sizes or the same size. In various embodiments, each heating element 104a, 104b, 104c may draw any amount of power or about the same amount of power. In various embodiments, each heating element 104a, 104b, 104c may draw about 1 W to about 36 W. In various embodiments, each heating element 104a, 104b, 104c may be about 8.27 in ×11.69 in, or about the size of an A4 sheet of paper. In various embodiments, each heating element 104a, 104b, 104c may be about 5 in ×5 in to about 20 in×20 in. Other sizes are contemplated for each of the plurality of heating elements 104.

In various embodiments, control module 106 may control one or more heating elements 104a, 104b, 104c separately. In various embodiments, control module 106 may provide power to only one heating element (e.g., heating element 104a), while not providing power to the other heating elements (e.g., heating elements 104b, 104c). Control module 106 may, in various embodiments, alternate which heating element of the plurality of heating elements 104 receives power at any given time. As mentioned, the control module 106 may provide full or partial power when alternating power to each of the plurality of heating elements 104. In various embodiments, control module 106 may include a single battery that alternately powers the plurality of heating elements. In various embodiments, the battery may be a 5-volt to 12-volt battery. In various embodiments, control module 106 may include a timer that allows control module 106 to alternate between heating elements 104 after a certain amount of time. In various embodiments, control module 106 may communicate with a heat sensor that allows control module 106 to alternate between heating elements 104 after the heating element reaches a certain temperature. The heat sensor may be located on and/or connected to each of the plurality of heating elements 104.

Alternating power to each heating element 104a, 104b, 104c tends to increase the lifespan of the battery with little to no reduction (or perceived reduction) in heating quality of electric blanket 100. Three heating elements (i.e., heating elements 104a, 104b, 104c) are illustrated and described herein for case of discussion. It should be appreciated that more or fewer heating elements may be used.

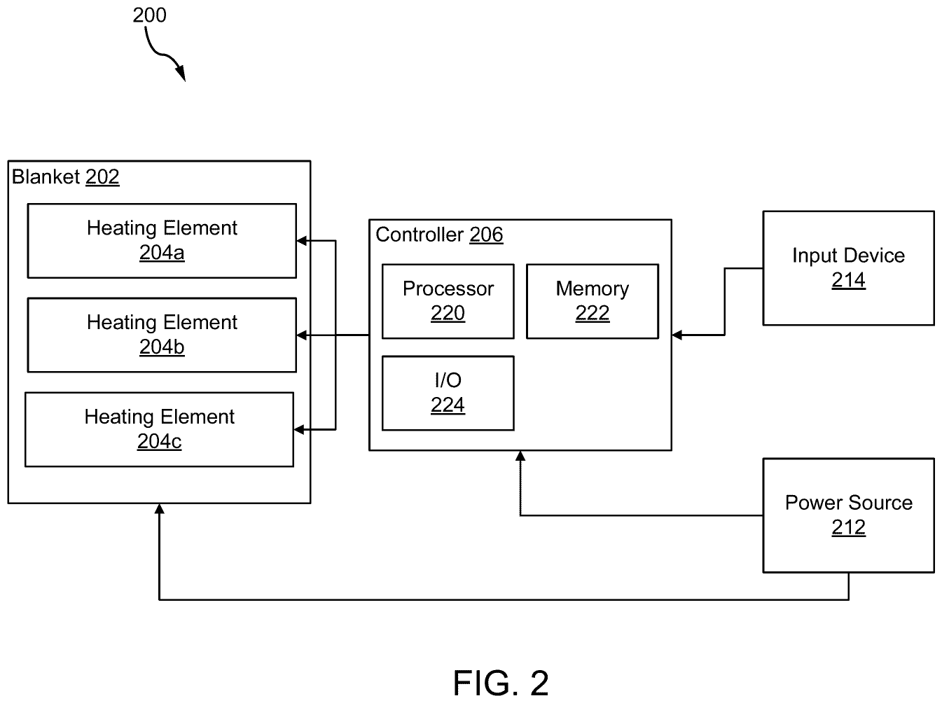

Referring now to FIG. 2, a schematic diagram of an electric blanket system 200 is illustrated, in accordance with various embodiments. System 200 may be an example of electric blanket 100 described above in FIG. 1, and as such, descriptions of similar components may not be repeated below. System 200 includes a blanket 202, a first heating element 204a, a second heating element 204b, a third heating element 204c, a controller 206, a power source 212, and an input device 214. Controller 206 may, in various embodiments, be an example of control module 106 described above in FIG. 1.

Power source 212 may be in communication with controller 206 and/or blanket 202. In particular, power source 212 may be in communication with heating elements 204a, 204b, 204c. Power source 212 provides the power to operate controller 206 and heating elements 204a-204c. Power source 212 may, in various embodiments, be a battery, solar power or any other power source. In various embodiments, power source 212 may additionally, or in the alternative, include a power cable to use a standard electric outlet and power converter to convert the standard alternating current (AC) power to direct current (DC) power used by system 200. In various embodiments, the battery may be a single 5-volt to 12-volt battery, a plurality of 1.5-volt batteries (e.g., AAA, AA), or other battery.

Input device 214 is used to select a heat setting for system 200, and more specifically, for heating elements 204a-204c. In various embodiments, input device 214 may allow a user to select one of a plurality of heat settings for heating elements 204a-204c. In various embodiments, the plurality of heat settings may include any number of heat settings (e.g., four heat settings).

In various embodiments, input device 214 may be any device communicating (e.g., wirelessly or wired) with system 200 such as a knob, a dial, a plurality of buttons, voice receiver (e.g., Google Alexa), smart phone or other control. In various embodiments, input device 214 may be coupled directly or indirectly to blanket 202. In various embodiments, input device 214 may be separate from blanket 202.

In various embodiments, input device 214 may include a remote control and a receiver. In various embodiments, the remote control and the receiver may communicate using radio frequency (RF). In various embodiments, the remote control and the receiver may communicate using infrared light (IR). In various embodiments, the remote control may be a hand held device (e.g., a smartphone, a tablet, Alexa, etc.) that communicates with the receiver using one of the IEEE 802.11 (Wi-Fi™), IEEE 802.15.1 (Bluetooth®), or IEEE 802.15.4 (Zigbee) standards, among others. In various embodiments, input device 204 may include more than one remote control.

Controller 206 includes a processor 220, a memory 222, and an input/output 224. Input/output 224 is configured to communicate with input device 214 using any of the standards and/or protocols previously described. Input/output 224 is further configured to control power to heating elements 204a-204c, individually. Specifically, input/output 224 may send a first signal to individually turn on power to one or more heating elements 204a-204c and a send a second signal to individually turn off power to one or more heating elements 204a-204c. In various embodiments, power to each heating elements 204a-204c may be controlled by a switch (e.g., a metal-oxide-semiconductor-field-effect transistor (MOSFET)). Controller 206 may then control power to each heating element 204a-204c by turning each individual switch on or off.

Controller 206, and more specifically, processor 220 is configured to control power to one or more heating elements 204a-204c based at least in part on the heat setting selected by input device 214. In various embodiments, controller 206 may save the selected heat setting to memory 222. In various embodiments, controller 206 may retrieve the saved heat setting from memory 222 on power up. As described above, there may be a plurality of heat settings. For example, the plurality of heat settings may include four heat settings including a setting 1, a setting 2, a setting 3, and a setting 4. In various embodiments, each setting 1-4 may correspond to the amount of heat output by heating elements 204a-204c. Each setting 1-4 may further define a pre-heat duty cycle, a pre-heat application time period, a total pre-heat time period, an operation duty cycle, and an operation application time period.

For example, setting 4 may correspond to the highest heat setting for blanket 202 and heating elements 204a-204c. The heat setting 4 may correspond to a pre-heat duty cycle of 100%, a pre-heat application time period of 10 ms, a total pre-heat time period of 55 minutes, an operation duty cycle of 68% power on and 32% power off, and an operation application time period of 10 ms. That is, on power up, controller 206, and more specifically, processor 220 obtains the heat setting and enters a pre-heat mode. In the pre-heat mode, controller 206 turns power on to each heating element 204a-204c, sequentially, for the pre-heat application time period of 10 ms at the pre-heat duty cycle of 100%. That is, in the pre-heat mode, controller 206 turns on power to each heating element 204a-204c sequentially for 10 ms each. In other words, controller 206 turns on power to heating element 204a for 10 ms while turning off power to heating elements 204b, 204c. Controller 206 then turns off power to heating elements 204a, 204c and turns on power to heating element 204b for 10 ms. Controller 206 then turns off power to heating elements 204a, 204b and turns on power to heating element 204c for 10 ms. Controller 206 continues this cycle for the total pre-heat time period, or 55 minutes in this example. This preheats heating elements 204a-204c to a desired heat while using about one-third the power that would be used if all heating elements 204a-204c were operated simultaneously.

After the total pre-heat time period ends (e.g., 55 minutes in this example), controller 206 enters operation mode. In operation mode, controller 206 turns power on to one or more heating elements 204a-204c, sequentially, for the operation application time period according to the operation duty cycle. In this example, the operation application time period is 10 ms and the operation duty cycle is 68% power on and 32% power off. That is, controller 206 turns off power to heating elements 204b, 204c and turns on power to heating element 204a for 6.8 ms and then turns off power to heating element 204a for 3.2 ms. Controller 206 then repeats this for each of heating elements 204b, 204c as described above with respect to the pre-heat mode. In various embodiments, controller 206 remains in operation mode until system 200 is powered off. In various embodiments, controller 206 remains in operation for a set time period of about 4 hours to about 8 hours.

The other settings (e.g., settings 1-3) operate the same as described above for setting 4, but with corresponding values. For example, the heat setting 3 may correspond to a pre-heat duty cycle of 100%, a pre-heat application time period of 10 ms, a total pre-heat time period of 33 minutes, an operation duty cycle of 52% power on and 48% power off, and an operation application time period of 10 ms. The heat setting 2 may correspond to a pre-heat duty cycle of 100%, a pre-heat application time period of 10 ms, a total pre-heat time period of 16 minutes, an operation duty cycle of 36% power on and 64% power off, and an operation application time period of 10 ms. The heat setting 1 may correspond to a pre-heat duty cycle of 100%, a pre-heat application time period of 10 ms, a total pre-heat time period of 8 minutes, an operation duty cycle of 20% power on and 80% power off, and an operation application time period of 10 ms.

In various embodiments, each heat setting (e.g., settings 1-4) may have an operational duty cycle of about 15% to about 75% on and about 25% to about 85% off. In various embodiments, each heat setting may have a total pre-heat time of about 5 minutes to about 60 minutes. In various embodiments, each heat setting may have a pre-heat application time period of about 5 ms to about 15 ms. In various embodiments, each heat setting may have an operational application time period of about 5 ms to about 15 ms. Other values and ranges are contemplated based on the desired heat production of each heat element 204a-204c and/or the desired battery life of power source 212.

Processor 220 may comprise one or more processors configured to implement one or more logical operations in response to execution of instructions, for example, instructions stored on a non-transitory, tangible, computer-readable medium. The one or more processors can be a processing chip, a general-purpose processor, a microprocessor, a microcontroller, a digital signal processor (DSP), an application specific integrated circuit (ASIC), a field programmable gate array (FPGA) or other programmable logic device, discrete or transistor logic, discrete hardware components, or any combination thereof. Memory 222 may comprise memory to store data, executable instructions, system program instructions, and/or controller instructions to implement the control logic of processor 220.

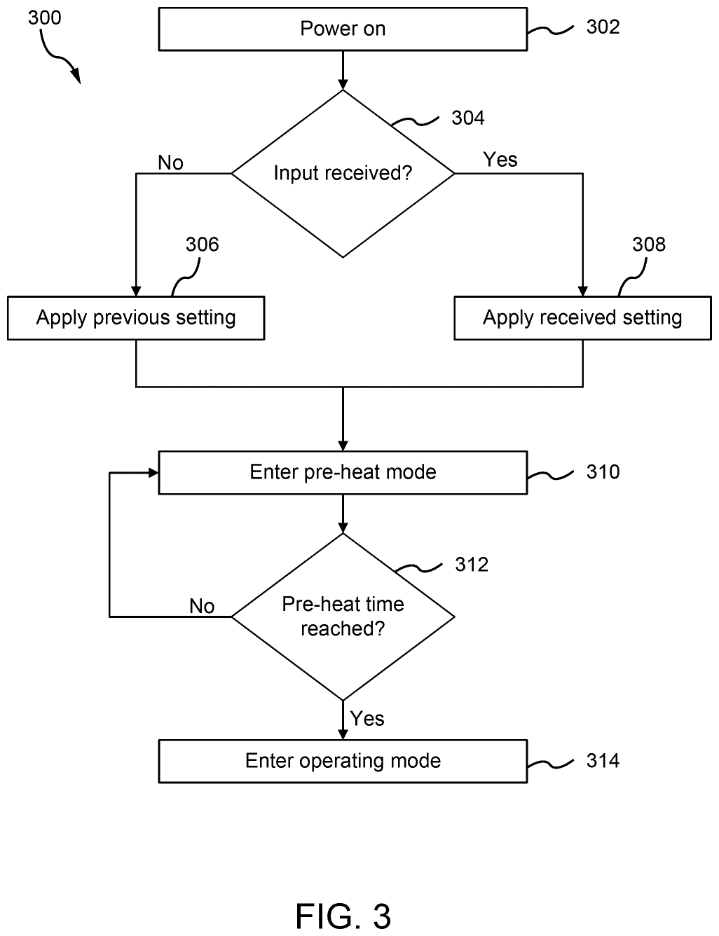

Referring now to FIG. 3, a flow diagram of a method 300 for controlling an electric blanket is illustrated, in accordance with various embodiments. In various embodiments, the steps of method 300 may be performed by control module 106 described above in FIG. 1. In various embodiments, the steps of method 300 may be performed by controller 206, and more specifically, by processor 220 described above in FIG. 2.

At block 302, processor 220 is powered on along with the electric blanket (e.g., electric blanket 100, blanket 202) and the plurality of heating elements located in the electric blanket. the electric blanket, including a processor, is powered on.

At decision block 304, processor 220 determines whether in input was received. If it is determined that an input was not received, method 300 proceeds to block 306. At block 306, processor 220 retrieves a heat setting from memory and applies the retrieved heat setting. Returning to decision block 304, if instead, it is determined that an input was received, method 300 proceeds to block 308. At block 308, processor 220 applies the heat setting received as input. As described above in FIG. 2, the heat setting may be one of a plurality of heat settings that indicate a desired level of heat to be produced and/or retained by the electric blanket.

At block 310, processor 220 enters pre-heat mode. Processor 220 identifies a pre-heat duty cycle, a pre-heat application time period, and a total pre-heat time period associated with the applied setting. In various embodiments, the pre-heat duty cycle may be about 90% to about 100% power on and about 0% to about 10% power off. In various embodiments, the pre-heat application time period may be about 5 ms to about 15 ms. In various embodiments, the total pre-heat time period may be about 5 minutes to about 60 minutes.

At decision block 312, processor 220 determines whether the total pre-heat time has been reached and/or exceeded. If it is determined that the total pre-heat time as not been reached, method 300 returns to block 310 to continue pre-heating the electric blanket. If, instead, it is determined that the total pre-heat time as been reached and/or exceeded, method 300 proceeds to block 314.

At block 314, processor 220 enters operating mode. Processor 220 identifies an operation duty cycle and an operation application time period associated with the applied setting. In various embodiments, the operation duty cycle may be about 15% to about 75% power on and about 25% to about 85% power off. In various embodiments, the operation application time period may be about 5 ms to about 15 ms. Processor 220 remains in operation mode until a shutdown condition is met. In various embodiments, the shutdown condition is the electric blanket being powered off. In various embodiments, the shutdown condition may be the electric blanket being powered on for more than a set time period. In various embodiments, the set time period may be about 4 hours to about 8 hours.

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. An individual component may be comprised of two or more smaller components that may provide a similar functionality as the individual component. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Furthermore, any reference to singular includes plural embodiments, and any reference to more than one component may include a singular embodiment. Use of ‘a’ or ‘an’ before a noun naming an object shall indicate that the phrase be construed to mean ‘one or more’ unless the context sufficiently indicates otherwise, as set forth in Slip op. at 8-9 (Fed. Cir. Oct. 19, 2023) (citing Baldwin Graphic Sys., Inc. v. Siebert, Inc., 512 F.3d 1338, 1342-43 (Fed, Cir. 2008)). For example, the description or claims may refer to a processor for convenience, but the invention and claim scope contemplates that the processor may be multiple processors. The multiple processors may handle separate tasks or combine to handle certain tasks. Although specific advantages have been enumerated herein, various embodiments may include some, none, or all of the enumerated advantages. A “processor” may include hardware that runs the computer program code. Specifically, the term ‘processor’ may be synonymous with terms like controller and computer and should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process and may include values that are within 5% of a stated value. Additionally, the terms “substantially,” “about” or “approximately” as used herein represent an amount close to the stated amount that still performs a desired function or achieves a desired result. For example, the term “substantially,” “about” or “approximately” may refer to an amount that is within 5% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A system, comprising:
a first heating element;
a second heating element; and
a controller in communication with the first heating element and the second heating element, wherein the controller is configured to obtain a heat setting, alternately apply a voltage to the first heating element for a pre-heat duty cycle and to the second heating element for the pre-heat duty cycle for a total pre-heat time period based at least in part on the heat setting, and alternately apply the voltage, after the total pre-heat time period, to the first heating element for an operating duty cycle and the second heating element for the operating duty cycle based at least in part on the heat setting.

2. The system of claim 1, further comprising a fabric material enclosing the first heating element and the second heating element.

3. The system of claim 1, wherein the heat setting indicates a pre-heat setting and an operating setting, wherein the pre-heat setting defines the pre-heat duty cycle and the total pre-heat time period, and wherein the operating setting defines the operating duty cycle.

4. The system of claim 1, wherein the alternately applying the voltage includes applying the voltage only to the first heating element for a first time period and applying the voltage only to the second heating element for a second time period after the first time period, the second time period being equal in length to the first time period.

5. The system of claim 4, wherein the first time period is about 5 ms to about 15 ms.

6. The system of claim 1, wherein the pre-heat duty cycle is 100% on and the operating duty cycle is about 15% to about 75% on and about 25% to about 85% off.

7. The system of claim 1, wherein the total pre-heat time period is about 5 minutes to about 60 minutes.

8. A system, comprising:
a power source;
a first heating element in communication with the power source;
a second heating element in communication with the power source;
a processor in communication with the power source, the first heating element, and the second heating element; and
a memory in communication with the processor, the memory comprising instructions stored thereon that, when executed by the processor, cause the processor to:
obtain a heat setting;
alternately apply a voltage from the power source to the first heating element for a pre-heat duty cycle and a first time period and to the second heating element for the pre-heat duty cycle and the first time period for a total pre-heat time period based at least in part on the heat setting; and
alternately apply the voltage from the power source to the first heating element for an operating duty cycle and a second time period and the second heating element for the operating duty cycle and the second time period based at least in part on the heat setting.

9. The system of claim 8, further comprising a fabric material configured to enclose the first heating element and the second heating element.

10. The system of claim 8, wherein the heat setting indicates a pre-heat setting and an operating setting, wherein the pre-heat setting defines the pre-heat duty cycle and the total pre-heat time period, and wherein the operating setting defines the operating duty cycle.

11. The system of claim 8, wherein the first time period is equal to the second time period.

12. The system of claim 8, wherein the pre-heat duty cycle is 100% on and the operating duty cycle is about 15% to about 75% on and about 25% to about 85% off.

13. The system of claim 8, wherein the total pre-heat time period is about 5 minutes to about 60 minutes.

14. The system of claim 8, wherein the first time period is about 5 ms to about 15 ms.

15. A method, comprising:
obtaining, by a processor, a heat setting;
applying, by the processor, a voltage alternately to each heating element of a plurality of heating elements for a total pre-heat time period based at least in part on the heat setting, the voltage being applied to each heating element of the plurality of heating elements according to a first duty cycle; and
applying, by the processor in response to the total pre-heat time period expiring, the voltage alternately to each heating element of the plurality of heating elements according to a second duty cycle based at least in part on the heat setting.

16. The method of claim 15, wherein the applying the voltage alternately further comprises:
applying the voltage according to the first duty cycle to each heating element of the plurality of heating elements for a first time period; and
applying the voltage according to the second duty cycle to each heating element of the plurality of heating elements for a second time period.

17. The method of claim 15, wherein the heat setting indicates a pre-heat setting and an operating setting, wherein the pre-heat setting defines the first duty cycle and the total pre-heat time period, and wherein the operating setting defines the second duty cycle.

18. The method of claim 15, further comprising:
receiving, by the processor, a input signal indicating the heat setting; and
storing, by the processor, the heat setting in memory.

19. The method of claim 15, wherein the first duty cycle is about 90% to about 100% on and about 10% to about 0% off, and wherein the second duty cycle is about 15% to about 75% on and about 25% to about 85% off.

20. The method of claim 15, wherein the total pre-heat time period is about 5 minutes to about 60 minutes.
